(19) United States
(12) Patent Application Publication
(10) Pub. No.: US 2019/0122457 A1
(43) Pub. Date: Apr. 25, 2019

(54) METHOD AND SYSTEM TO DELIVER TELEMATICS SOLUTIONS

(71) Applicants: APOSTOLOS NIKOLAIDIS, PIRAEUS (GR); IOANNIS CONDELLIS, ATHENS (GR); FOTIOS ANDRITSOPOULOS, PIRAEUS (GR)

(72) Inventor: FOTIOS ANDRITSOPOULOS, PIRAEUS (GR)

(21) Appl. No.: 16/089,677

(22) PCT Filed: Apr. 1, 2016
(86) PCT No.: PCT/GR2016/000015

§ 371 Date: Sep. 28, 2018

(51) Int. Cl. G07C 5/08; G07C 5/00; G06Q 30/04; G06Q 50/30; H04L 29/06; H04L 29/08

(52) U.S. Cl. CPC G07C 5/0808; G07C 5/008; H04L 67/125; G06Q 50/30; H04L 63/0892; G06Q 30/04

(57) ABSTRACT

A method and system to develop, test, debug and deploy telemetry and telematics solutions is disclosed. The method allows application developers and telematics service providers to ease the building, deployment and maintenance of telemetry and telematics solutions. The system provides a configurable mobile application in the role of soft telematics box and a web-based platform that allows the remote configuration, testing and licensing of the mobile application. System also, provides a Broker and an API that facilitate the Consumption of telematics/telemetry data from the Application to be developed.

### TECHNICAL FIELD

The present disclosure described herein, in general, analyzes the functionality of a computing system that interconnects and manages people and things over the Internet. More particularly, it relates to a method that provides a development and test platform to build software applications that manage data about location, sensors and peripherals for people, vehicles and things.

### BACKGROUND ART

Existing fleet management systems typically include a telematics unit most often hardwire installed into the vehicle. Along with the GPS related data, like position, speed, heading, height, etc., a telematics unit may also acquire and upload to a telematics server, data retrieved from various vehicle sensors, like engine temperature, RPM, fuel consumed, odometer mileage counter, door status, diagnostics and many other. A personal navigation device (PND) may also be connected to a telematics unit to access the internet and thus to allow the communication of the driver with the fleet operations center. To save installation costs, some modern PNDs exploit the driver's smartphone instead of the telematics unit to access the internet.

Before a telematics service provider (TSP) starts providing their services to the end customers, the TSP has to select among multiple hardware vendors, to integrate the vendor specific communication protocols into its own telematics platform and then to perform the complex in-vehicle fitting. Usually, TSPs are providing a certain bundle of services, so the first two steps are usually required only once a new telematics unit or a PND is to be supported.

Hardware selection, integration and testing are tough tasks for a TSP and in many cases they are the main barriers for TSPs to frequently enrich their offered services with innovative features supported by the emerging telematics units. While this is the case for most of the TSPs, there are few ones, like Gurtam with the Wialon platform that have invested a lot on integrating a large number of telematics units from various vendors.

Also, few large TSPs, like Omnitracks are manufacturing their own hardware to support their telematics services. This gives them significant marketing advantage, since they can continuously putting new features into their telematics units and offer very competitive telematics services. This partly explains why those TSPs are less than 1% of the TSPs globally and occupy around the 20% of the global market. The rest 99% is bundled with one or more hardware vendors. A hardware-agnostic solution would change the rules of the game in telematics, since it would decouple the majority of TSPs from the hardware vendors, enabling them to offer much more innovative services and being differentiated in the market.

Recently, there are some new trends in modern telematics that cut the vehicle fitting costs. The GSM/GPS-enabled OBDII dongles that are small factor pluggable telematics units and the telematics mobile applications running in the driver's smartphone or tablet. While the first category of devices can perform several telematics functions related to vehicle tracking and vehicle parameters monitoring, they lack a human interface and thus they cannot support an important feature of modern telematics that is the “Connected Driver”. Also, they lack beyond-the-vehicle monitoring capabilities, like for example proximity sensing of Bluetooth Low Energy (BLE) Tags used for Cargo and Asset tracking.

On the other hand, the concept of deploying telematics services via smartphones and tablets is becoming more and more popular. Smartphones and Tablets have large processing and memory capabilities, are equipped with the most widely used peripherals for telematics (GPS, GSM/GPRS, User Interface) and with extra communication interfaces like Bluetooth, Wi-Fi and NFC to support the next generation of fleet and mobile workforce management based on the Internet of Things (IoT).

Several patents and products, like US2015/0163649, US2015/0242769, U.S. Pat. Nos. 8,457,880, 8,928,495, Wejo, Spedion and Mycartracks already exist for insurance telematics, fleet and mobile workforce management. All known patents and products focus on some smart methods and systems to address a specific application area. None of them is proposing a general purpose solution that would allow any TSP to easily develop, test and deploy its services, via a hardware and software agnostic, mobile-based solution. No any solution is found yet, that allows a TSP to rapidly deploy and life-cycle manage its services by just configuring a general purpose telematics mobile application via a user friendly web interface.

The challenge is to alleviate the need of TSPs for specific hardware adoption or mobile application software development and enable them to focus on creating more innovative cloud-based services. Certainly, Smartphones and Tablets are not designed to cover any kind of telematics application, like for example the tracking of trailers and containers. However, the recent trend for ruggedized mobile devices enables them to cover an even larger range of fleet and mobile workforce management applications.

### SUMMARY OF INVENTION

Before the present methods, systems, and hardware enablement are described, it is to be understood that this disclosure is not limited to the particular systems, and methodologies described, as there can be multiple possible embodiments of the present disclosure which are not expressly illustrated in the present disclosure. It is also to be understood that the terminology used in the description is for the purpose of describing the particular versions or embodiments only, and is not intended to limit the scope of the present disclosure.

In a first embodiment, a set of services is integrated in a mobile device to collect information, from telematics environment and further process and decide, if these data need filtering, storage, transmission, or to create local events. In this embodiment the system publishes its information to a message broker located in the cloud platform in the form of APIs. The information is encrypted using standard encryption methods and is compressed using standard compression methods. The mobile device plays the role of the classic telematics device with enhanced characteristics supporting a plurality of sensors and peripherals. In this embodiment, the mobile device maintains a connection with the cloud platform for data exchanging. However, it should be understood that in other embodiments, mobile devices may connect to the cloud server to upload its data occasionally while the mobile device uses a store and forward mechanism.

In another embodiment a system includes a message broker configured to identify and classify messages published by mobile devices according to the topic that each set of information is published to. In this embodiment message broker informs authorized subscribers about its data received on its topic in the form of APIs. In some embodiments the broker may integrate additional services to consume the published data for demonstration purposes.

In another embodiment a system includes a mobile management platform which sets the permissions to mobile users to download and install applications, to control security settings and present licensing and billing information. Telematics service providers create accounts to massively control and manage a plurality of mobile devices. Mobile device management platform (103) can reconfigure in real time the mobile device by pushing new profile, altering configuration parameters, or by uploading a white list with a set of applications allowed to be executed by the user. In this embodiment the account manager can optionally provide to the user the ability to temporarily bypass the security mechanism and gain full access to the mobile device.

### DISCLOSURE OF INVENTION—DETAILED DESCRIPTION

Detailed embodiments of the present invention are disclosed herein; before the present methods and systems are described, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

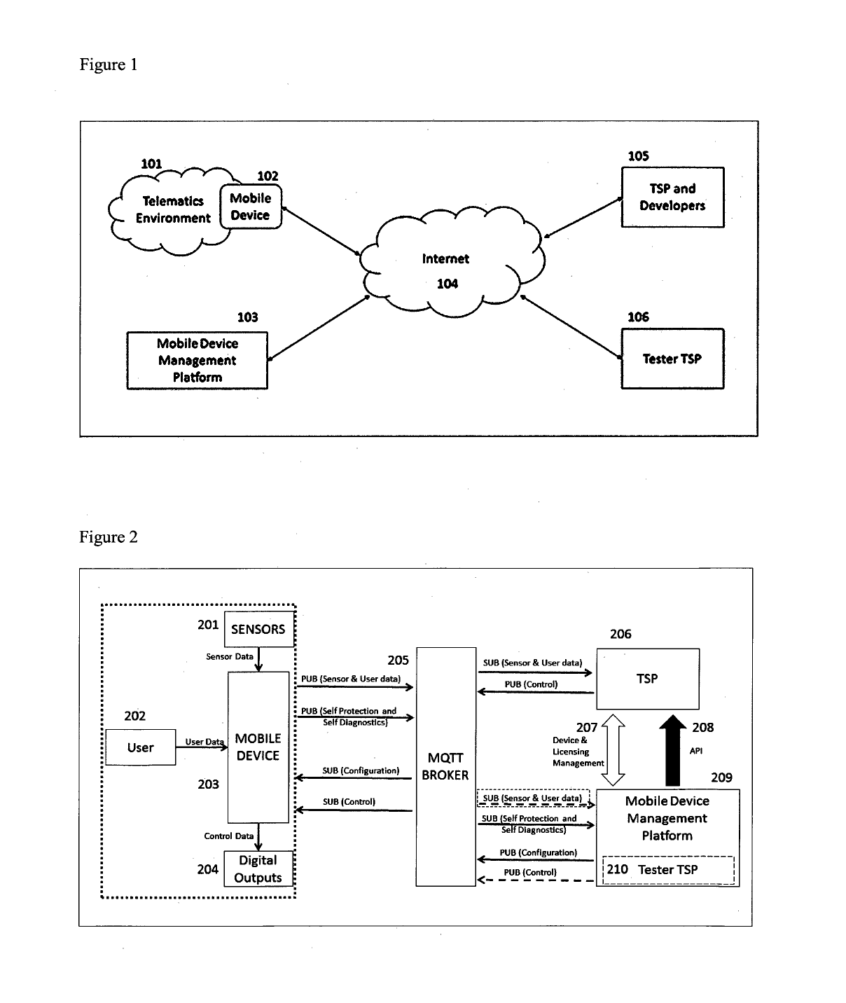

FIG. 1 illustrates an example topology of the overall system comprising a multitude of TSPs (105) each deploying various telematics services via a multitude of mobile devices (102) each operating within a smart telematics environment (101). TSP block (105) represents any backend cloud server connected with a database and gathering telemetry data and transmitting control data on behalf of a Fleet Management Service Provider (FMSP), an Insurance Telematics Service Provider (ITSP), a Mobile Workforce Management Provider (MWMP) or any other custom applications developer. Mobile device (102) may be any hardware element with processing, memory and networking capabilities such as a smartphone or tablet, a vehicle infotainment system and a wearable computer such as a smart watch or smart glasses. The smart telematics environment (101) may be consisted of sensors either built-in the mobile device or operating in its vicinity. Further, the telematics environment (101) comprises various hardware elements receiving and executing commands to control digital outputs driving relays, actuators and so on. The mobile device (102) may communicate with the smart telematics environment (101) via a multitude of connectivity options such as USB, Bluetooth, NFC, Wi-Fi, etc.

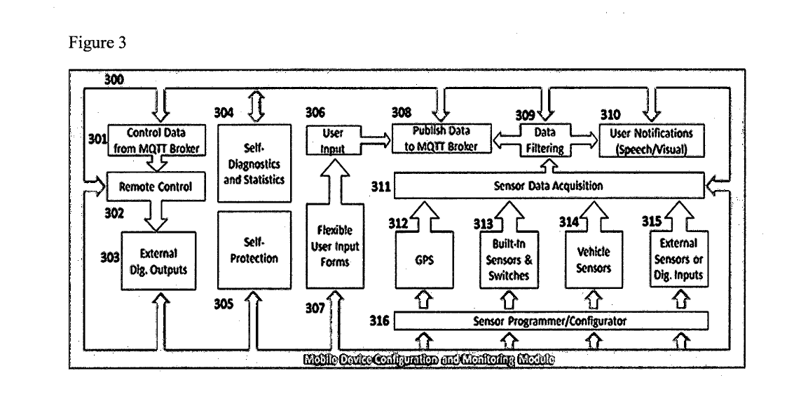

Mobile Device Management Platform (103) provides a web interface to developers allowing them to enable, configure, control and diagnose any operation performed by the mobile device (102) and its smart telematics environment (101). Telemetry data acquisition, filtering, remote control, self-protection and licensing are the main operations managed via the web interface of (103). More details about the managed operations are given below (FIG. 3). The management platform (103) comprises a cloud server that communicates with the mobile device (102) to exchange configuration, diagnostics and self-protection information. A database is connected to the cloud server of (103) to store the foregoing information.

In FIG. 1, the Tester TSP (106) is a similar implementation of TSP (105), in terms of the backend cloud server and the database connected to it. However, the backend cloud server is configured to receive and transmit every possible information from and to the mobile device (102). Additionally, Tester TSP (106) implements a web interface through which a developer can fully and rapidly test both the mobile device (102) and its telematics environment (101) before design and develop its own telematics application.

All subsystems described above (101), (102), (103), (105) and (106) communicate over the Internet (104) as depicted in FIG. 1. The network infrastructure (103) could be realized also using local area networks (LANs) or metropolitan area networks (MANs).

FIG. 2 depicts the data exchange among the mobile device (203), TSP (206) and management platform (209). The mobile device (203) communicates with the sensors (201) and with the mobile user (202) and uploads Sensor and User data to TSP (206). The mobile device (203) downloads Control data from TSP (206) to control digital outputs (204) existing in the vicinity of or being connected to the mobile device (203). The management platform (209) uploads the configuration data onto the mobile device (203) and downloads Self-protection and Diagnostics information from it (203).

To better facilitate all the foregoing data exchanges, the publish/subscribe model may be deployed. The publish/subscribe model may utilize topics through which publishers may send messages and subscribers may receive messages. In an embodiment, message queue telemetry transport (MQTT) may be utilized as the message transport protocol, providing publish/subscribe functionality and quality of service options for message delivery. The central element in the publish/subscribe model is the message Broker (205) that maintains several topics in order to publish information towards mobile devices and receive data from them using subscription on the broker. The topics can be classified into four major categories to cover most of the telematics applications; however the categories can be extended for other applications as well.

The first category includes the Sensor and User data. Sensors (201) collect data continuously and forward the respective values to the mobile device (203) through “Sensor data” path. The term “Sensor data” stands for every type of data derived from sensors such as temperature, humidity, acceleration and in general every electronic device that automatically collects information from the environment and deliver that information to a mobile device. This topic includes also data from the user of the mobile device (203). User data could be any type of input directly from the user using a kind of forms presented in the screen of the mobile device (203); Text, audio and video are content types that the user may submit to the mobile device. To gather data, the TSP (206) may subscribe to all or to a specific set of topics related to Sensor and User data category, while the mobile device (203) publishes to all topics belonging to the Sensor and User data.

The second category of topics involves the Control data and represents any control command originating from TSP (206) and targeting the Digital Outputs controller elements (204). The mobile device (203) is subscribed to all or to a specific set of Control topics, while the TSP (206) publishes to all topics belonging to the Control data category. The mobile device (203) listens for control commands sent from the TSP (206), process and then transmits them via the “Control data” path to any kind of electronic device (204) able to control digital outputs and drive any kind of electronic or electrical equipment, such as relays, actuators, motors, buzzers, etc.

Both of the above topic categories are related to the data exchange between the TSP (206) and the mobile device (203). The rest two categories facilitate the management of the telematics services provided via the mobile device. The first category for management purposes comprises the Configuration topics. The mobile device (203) subscribes to all or to a specific set of configuration topics to receive messages published from the management platform (209). Configuration topics involve any configuration parameter related to the mobile device operations being analyzed in FIG. 3 below. Information related to the mobile device health status, telematics services status and abnormal or unauthorized use of the mobile device is organized into several topics formatting a special category named Self-Protection and Diagnostics. To exchange this information, the management platform (209) subscribes to all or to a specific set of Self-Protection and Diagnostics topics, while the mobile device (203) publishes to all topics of this category.

The management platform (209) provides TSPs (206) with a complete set of APIs (208) that allow the extraction of the Sensor and User data received from the mobile devices (203) as well the construction of the Control data to be sent to the mobile devices. Those APIs (208) are a direct interface to the cloud and thus TSPs do not need to consider about management, scalability, network capacity, availability and in general, whatever may affect the performance of the overall system. Also, the management platform (209) provides TSPs with a Web interface (207) via which a TSP developer can build its own set of configuration settings, i.e. configuration profiles and upload them to a selected set of mobile devices in order to enable its custom telematics service. Further, (207) implements an online store through which a TSP administrator may update the license for the disclosed Platform as a Service (PaaS) per mobile device (203) deployed.

For testing and validation purposes, the platform implements the “Tester TSP” subsystem that emulates real TSPs. Tester TSP (210) uses the same APIs (208) and implements a full featured test application allowing a TSP developer to verify the underlying functionality between hardware and software components. TSP developer can validate the operation of the demo application having a feature-proofed solution before starting developing its own custom application.

In network level, all main entities, i.e. the mobile device (203), the TSP (206), the Management Platform (209) and Tester TSP (210) maintain an active connection with the broker. It is preferable for the Control, Sensor and User data to be delivered in real time, but the system is designed to work normally, even with a poor network connection, even if the connections goes up and down (not permanent).

FIG. 3 illustrates the architecture of the Mobile Device part of the system. The main component of the disclosed system is the mobile device configuration and monitoring module (300). Via the message transport mechanisms described in FIG. 2, module (300) conveys configuration settings from the mobile device management platform (FIG. 2, 209) to the functional components of the mobile device (301-307, 308-311 and 316) as depicted by gray arrows. Moreover, module (300) conveys diagnostics and statistics information from the mobile device to the mobile device management platform. Module (304) undertakes to gather self-diagnostics and statistics information from the mobile device and pass it to module (300). Connection status with the built-in sensors or with the external sensors are some indicative examples of self-diagnostics information that a TSP could deploy to solve any potential issues with its telematics service. The data traffic consumed by each mobile device is an example of statistics needed to be remotely gathered by TSPs.

A mobile device may use either the built-in GPS or an external GPS module (312) via a wireless network, like Bluetooth to acquire position related data. Further, it may acquire information from other built-in sensors and switches (313), such as Turn On/Off and Volume Up/Down buttons, accelerometer, compass, microphone, camera, temperature, fingerprint sensor, etc. When in-vehicle, a mobile device may communicate wirelessly (e.g. via Bluetooth or Wi-Fi) with an OBD dongle or a hardwire installed CAN-bus reader (314) to acquire vehicle-sensors data, like diagnostics, engine RPM, fuel consumed etc. In one embodiment the mobile device may be a part of the vehicles infotainment system such as Android Auto or Apple CarPlay. In this embodiment, the vehicle sensors (314) should be considered as part of the Built-in sensors (313). Further, the mobile device may be connected wired or wirelessly (e.g. via Bluetooth or Wi-Fi) to external sensors (315) to acquire data related to the surrounding space. External sensors consist of car dash cameras, health monitoring sensors, BLE, NFC or other wireless tags with proximity, temperature, humidity, pressure, digital inputs or other monitoring capabilities. Modules (312), (313), (314) and (315) maybe be upgraded and configured by a separate module (316), while they feed module (311) with their data. Both (311) and (316) operate as device drivers for any of the modules (312), (313), (314) and (315). Modules (311) and (316) may be configured remotely from the mobile device management platform (FIG. 2, 209) via the mobile device configuration and monitoring module (300) operating in the mobile device. For example, an aftermarket CAN-bus reader (314) with hundreds of pre-installed programs each corresponding to a specific vehicle model, may need the proper program number to operate correctly for a specific car. This number is provided by the TSP operator via the web interface of the mobile device management platform (FIG. 2, 209), it is received via the cloud by the module (300) and executed by module (316) which is responsible for programming and configuring the CAN-bus reader.

The sensor data collected by module (311) are processed by module (309). Depending on the specific application requirements, special rules may be applied by (309) to define the data to be sent to the cloud via module (308), the data to discard and the data that will generate local notifications and alerts via module (310). For example, while a GPS module may collect position data every 1 second, module (309) may send to the cloud just the 10% of the acquired GPS positions, i.e. at an interval of 10 seconds to save data traffic. Module (310) implement the visual and speech notifications of the mobile device user according to the input of the data filtering module (309). For example, every time GPS speed exceeds 1501 cm/hour, module (310) could activate the device speakers and prompt the user to slow down. Certainly, more complicated rules may be applied by module (309). Rules for module (309) as well user notification content and type for module (310) are set by the TSP operator via the mobile device management platform (FIG. 2, 209), then received via the cloud by module (300) which consequently feeds them to modules (309) and (310).

Module (308) implements a message transportation protocol such as MQTT and publishes both filtered Sensor data and User data arriving from block (306). Module (308) should always support store and forward functionality to cater with the unreliable networks most of the telematics applications are exposed to. It is preferable that the message transportation protocol supports natively the store and forward functionality via several quality of service options. Module (307) provides a customizable set of user input forms enriched with selection buttons that allow the mobile user to send and receive text and audio messages, photos and videos. This kind of functionality is required in modern mobile workforce management environments where the user should be always connected with the operations center. These flexible forms are customized by the TSP developer according to the specific application requirements. The customization is performed via the web interface of the mobile device management platform (FIG. 2, 209). The customization information is collected via the cloud by the module (300) and then is executed by the Flexible User Input Forms module (307).

Similarly to module (308) which publishes the Sensor and User data to the TSP, module (301) implements a message transportation protocol such as MQTT to receive control commands from the TSP. It then passes the control commands to module (302) which finally decides whether to execute or not each command based on specific rules set by the mobile device management platform via module (300). Module (302) ensures that nothing fatal should happen in any case. For example, if a TSP's customer send a command to stop remotely the car engine, module (302) should check the GPS speed, and it will execute the command only when GPS speed is 0 km/h to avoid any accident. Module (303) may communicate wired or wirelessly with any electronic equipment that controls one or more digital outputs. Module (303) can be configured remotely by the mobile device management platform via module (300). For example, module (303) could support wireless digital relays from various manufacturers each of them having its own communication and control protocol. Depending the implementation, the TSP may indicate to module (303) the specific digital relay to communicate with. This is performed via the mobile device management platform and module (300).

Module (305), allows the selective access to specific smartphone applications. Once activated by the mobile device management platform, module (305) locks the mobile device screen and presents only the allowed applications to be executed. This is to protect the mobile device itself from malicious applications and the workforce manager from user distracting and bandwidth wasting applications. It may also facilitate the protection of the disclosed mobile device management application itself. This is performed by prohibiting user access to any application offered by the mobile operating system that allow the uninstallation of mobile applications. For example, module (305) could deny access to the Settings and Play Store applications in Android device.

1. A system for providing a cloud based development, management, testing and deployment platform environment for telemetry and telematics solutions based on mobile devices with built-in sensors, external peripherals and user input said system comprising:
a. a set of system services embedded to mobile devices to collect, filter, format and reliable transmit sensor data, peripheral data and user input as received by the respective telematics environment;
b. an application programming interface with enhanced security and minimized data footprint provided to the telematics service providers to develop, test, debug and deploy end user applications based on data acquisition from sensors and peripherals;
c. a module that correlates, presents and demonstrates on the web the data collected from available sensors and peripherals and
d. a set of centralized management and control software tools that setup, and monitor the components of the platform over the web. Licensing and billing of mobile devices operating in the system is also a module of this toolchain.

2. The system of claim 1, wherein the set of system services comprise at least of services running on a mobile device with CPU, memory and processing capabilities along with a plurality of network interfaces for communications, peripherals, sensors and user interfaces for local interaction between the user and the mobile device.

3. The system of claim 1, wherein said collect, filter, format and reliable transmit are used to parse, analyze and organize big data before select the dataset to be transmitted from the mobile device towards cloud infrastructure.

4. The system of claim 1, wherein said enhanced security, services are enabled to establish an encrypted communication channel between at least two endpoints using standard security technologies between the mobile devices and the cloud platform.

5. The system of claim 1, wherein said minimized data footprint, services are enabled to minimize the amount of data exchanged between the mobile devices and the cloud platform, using standardized compression protocols and methods applied on data.

6. The system of claim 1, wherein said correlates, services are configured to correlate non time based sensor data and peripheral data with time based location data.

7. The system of claim 1, wherein said management and control software tools, services are enabled to remotely manage in real-time the mobile devices along with its sensors and peripherals.

8. The system of claim 1, wherein said licensing and billing, services are enabled to further configure in real-time the behavior of mobile devices according to licensing and billing records.

9. The system of claim 1, wherein said test platform, services are enabled to visualize and present for evaluation purposes, sensor data, peripheral data, events, user input and any low level data as acquired by the mobile devices.

10. The system of claim 2, wherein the peripherals for sensor data may stand for wired and/or wireless components that collect ambient information from the telematics environment including temperature, humidity, light, motion, magnetometer, audio, still pictures, video and field sensors.

11. The system of claim 2, wherein the user interface may stand for a screen/monitor, switches, buttons, microphones and cameras for interaction purposes and data submission between the mobile devices and the operating user in real-time.

12. The system of claim 4, wherein said cloud platform comprises:
a. a set of services for authentication, authorization and accounting of mobile devices operations and activities.
b. a message broker that acts as an intermediary to proxy traffic between mobile devices and the telematics service provider using well specified topics.
c. an application programming interface to deliver structured data to the telematics service provider filtered by each topic.

13. The system of claim 12, wherein said message broker is a software module for exchanging data among mobile devices and its peripherals, designed for constrained devices and low-bandwidth, high-latency or unreliable networks.

14. The system of claim 12, wherein said topics are predefined strings which are dynamically set to distinguish and filter messages for each connected device or subscribed developer.

15. The system of claim 12, wherein said well specified topics comprises at least of:
a. a topic between the mobile devices and the broker to exchange automatically sensor and user data
b. a topic between the mobile devices and the broker to exchange automatically self-protection and self-diagnostics data
c. a topic between the mobile devices and the broker to exchange configuration data asynchronously upon TSP's request
d. a topic between the mobile devices and the broker to exchange control data either automatically based on predefined criteria or asynchronously upon TSP's request

16. A method for providing a development platform, demonstration environment, deployment services and management of mobile devices and sensors to telematics service providers, comprising steps of:
a. configuring a mobile device to automatically authenticate itself and announce its presence to the platform and its will to be adopted and operate on that.
b. advertisement of the available topics that the platform is configured to support in order to setup communication channels to exchange data between the mobile devices and the subscribed developers. Data are classified based on topics and are destined both to authenticated subscribers and mobile devices.
c. maintaining a configuration manager to push and pull profile information for each connected mobile device.
d. remotely managing mobile devices and its sensors utilizing a standardized application programming interface.

17. The method of claim 16, wherein the authentication process is tightly coupled with mobile device's unique identifier as set by the hardware vendor.

18. The method of claim 16, wherein the announcement of its presence is performed using messages on specific topics related with mobile device's state, health status and adoption requests.

19. The method of claim 16, wherein advertisement of the available topics is the publishing of topics to subscribed and authenticated developers and applications, ready to receive and consume data related to these topics.

20. The method of claim 16, wherein configuration manager includes the procedure to compile a wide set of configuration parameters into a single message for further management and reconfiguration of mobile device and its sensors by publishing that message to a predefined topic for configuration purposes.

21. The method of claim 16, wherein the remotely management provides elevated privileges to the telematics service provider to fully manage the mobile devices regarding the application allowed to run and its sensors' behavior.

22. The method of claim 22, wherein said applications allowed to run, is a module implementing a security mechanism which remotely enables services to manage local permissions in order allow or deny specific, already installed, native applications to run on the mobile devices.

23. The method of claim 23, wherein said remotely enables services, comprise services running on the centralized management of cloud platform to set permissions over configuration message topic in order TSPs to define access on installed applications.

24. The method of claim 16, wherein said development includes the creation, starting, debugging and testing of the telematics service provider's application.

25. The method of claim 16, wherein said deployment services provide a seamless mechanism to massively deploy developed applications and use cases to a plurality of mobile devices.

26. The method of claim 23, wherein said developed applications comprise of native or web based applications deployed and hosted on telematics service provider's infrastructure.

27. The method of claim 23, wherein said use cases include a plurality of scenarios as modified by the telematics service provider to fulfill developed application's requirements.
